(19) United States
(12) Patent Application Publication
(10) Pub. No.: US 2026/0229771 A1
(43) Pub. Date: Aug. 6, 2026

(54) SATELLITE TRACKING SYSTEM

(71) Applicants: OVER-SAT LTD., Netanya (IL); MIL-SAT LLC, Surry, VA (US); ASSURED SPACE ACCESS, INC, Chandler, AZ (US)

(72) Inventors: Lior WEINSTEIN, Bat Hefer (IL); Donald Robert RICHARDSON, Winton, NC (US); Sean P. MCDANIEL, Humacao (PR)

(21) Appl. No.: 19/147,728

(22) PCT Filed: Aug. 31, 2023
(86) PCT No.: PCT/IL2023/050938

§ 371 Date: Jul. 14, 2025

(30) Foreign Application Priority Data
Jan. 12, 2023 (IL) 299853

(51) Int. Cl. H01Q 3/08; H01Q 15/08

(52) U.S. Cl. CPC H01Q 3/08; H01Q 15/08

(57) ABSTRACT

The present disclosure provides a system for allowing continuous tracking and communication with at least one satellite by a single antenna aperture. The system is designed so it can use a reduced number of antenna elements and consume a reduced amount of energy, with respect to other known satellite tracking systems. An arrangement of an array of antenna elements to conform with the shape of a spherical lens to allow electromagnetic radiation to be focused by the lens to at least one antenna element from the array; rotational movement of the lens about/around at least two axes; the ability to activate and deactivate each antenna element of the array.

### TECHNOLOGICAL FIELD

The present disclosure is in the field of satellite terminals.

### BACKGROUND ART

References considered to be relevant as background to the presently disclosed subject matter are listed below:
US 2014/0139370
U.S. Pat. No. 10,553,947

Acknowledgement of the above references herein is not to be inferred as meaning that these are in any way relevant to the patentability of the presently disclosed subject matter.

### GENERAL DESCRIPTION

The present disclosure provides a system for allowing continuous tracking and communication with at least one satellite by a single antenna aperture. The system is designed so it can use a reduced number of antenna elements and consume a reduced amount of energy, with respect to other known satellite tracking systems. The reduction of the number of antenna elements and the energy consumption is allowed due to a combination of the following elements: (i) an arrangement of an array of antenna elements to conform with the shape of a spherical lens to allow electromagnetic radiation to be focused by the lens to at least one antenna element from the array; (ii) rotational movement of the lens about/around at least two axes; (iii) the ability to activate and deactivate each antenna element of the array; and (iv) a processing circuitry, i.e. a processor, that is configured to (a) receive data of the satellites to be tracked at any time and (b) rotate the lens and selectively activate or deactivate any antenna element in synchronization with the rotational movement to allow the continuous tracking and communication with at least one satellite at any time. The system is configured to continuously transition between two states. At the first, two-satellites tracking, state, two satellites are being tracked, namely the processor continuously controlling the rotational position of the lens and the activated antenna elements to ensure that the two tracked satellites are positioned at the arc of communication defined by the antenna array, namely that each of the tracked satellites is aligned with the beam of at least one antenna element. When one of the two satellites exits the line of sight of the system or upon a command from the network management, the tracking and communication with it is terminated, and the system enters a second, transition period state, in which the processor continuously controls the rotation of the lens and the activation/deactivation of the antenna elements to continuously maintain tracking and communication with the other satellite of the two while aligning at least one activated antenna element with a third satellite that replaces the satellite that exited the line of sight of the system, which brings the system back to the first state and so on.

Therefore, a first aspect of the present disclosure provides a system for continuous tracking and/or communicating with at least one satellite. The system comprises a lens having a spherical or cylindrical symmetry, typically a Luneburg lens. The lens is mounted on a movable platform that is capable of independent rotation/movement about at least two axes, and more typically three axes, resulting in a respective rotation/movement of said lens, namely allowing roll, pitch and yaw of the lens. The system further comprises a first array of transmitting/receiving antenna elements, the first array is affixed, through at least a part of it, to a portion of the lens conforming with a contour of said portion of the lens, namely arranged in an arch along an arc, to allow transmission and/or detection of electromagnetic radiation through the lens. The fixed attachment can be according to one of the following: (i) external to the lens such that there is a gap between the antenna elements and the lens; (ii) such that the antenna elements are physically contacting the external surface of the lens; (iii) or that the antenna elements penetrate to some degree into the internal volume of the lens. The system further comprises a processing circuitry, (i.e. a controller, a processor, or a processing unit, configured for: (i) independently controlling the movement of the movable platform about each of the two or more axes; (ii) controllably activating and deactivating at least one antenna element of said first array; (iii) receiving satellite data indicative of the position of a primary satellite and a secondary satellite, the secondary satellite is the one that becomes the primary satellite upon either (1) exiting or about exiting of the primary satellite from the field of view or line of sight of the system or (2) upon receiving a command from the satellite network management; and (iv) based on the satellite data, controlling the movement of the movable platform and activating the desired antenna elements to continuously simultaneously track the primary and the secondary satellite, thereby being prepared for the loss of communication with the primary satellite and continuing the communication with the secondary satellite, which becomes the primary satellite for the next cycle of tracking.

It is to be noted that any combination of the described embodiments with respect to any aspect of this present disclosure is applicable. In other words, any aspect of the present disclosure can be defined by any combination of the described embodiments.

In some embodiments of the system, the movable platform comprises a seat or mounting portion on which the lens is mounted. The seat portion is coupled to a rotatable support frame that is rotatable about two non-parallel axes, first and second axes, by first and second drivers. In some embodiments, the first and second axes are orthogonal or normal.

In some embodiments of the system, the rotatable support frame encircling said lens, forming a closed loop around the lens.

In some embodiments of the system, the movable platform comprises two arms coupling the rotatable segment to a rotatable base. The rotatable base is rotatable by a third driver about a third, typically vertical, axis that is non-parallel to the first and second axes. In some embodiments the third axis is normal or orthogonal to at least one of the first and second axes. Therefore, by rotation of the rotatable support frame about two normal axes and the rotation of the base about an axis normal to the first two axes, all rotational movements are allowed to align the first array of elements with two satellites simultaneously so as to permit activation of two antenna elements to track the two satellites and perform continuous tracking and continuous satellite communication.

In some embodiments of the system, a mid-point of said first array coincides with the third axis in a neutral state. Namely, when the system is balanced with respect to the ground it is mounted on or in its pre-set state, the third axis passes through center of the arc. In other words, when the system is in its pre-set state, the sagitta of the arc defined by the first array coincides with the third axis.

In some embodiments of the system, one of the first and second drivers is formed on one of said two arms.

In some embodiments of the system, one of the first and second drivers is formed on said rotatable support frame.

In some embodiments of the system, a first driver is formed on one of said two arms and the second driver is formed on said rotatable support frame.

In some embodiments of the system, said first array is coupled to said seat for said fixed attachment.

In some embodiments of the system, said first array extends along an arc that is less than half of the perimeter of the lens.

In some embodiments of the system, said first array is fixed to the external surface of said lens.

In some embodiments of the system, at least some elements of said first array, or at times all elements, penetrate, at least partially, to an internal volume of said lens.

In some embodiments, the system further comprises a radar dome enclosing said lens and movable platform.

In some embodiments, the system further comprises an inertial measurement unit (IMU) that may comprise accelerometers and/or gyros or rate gyros and is configured to sense the orientational state of the system with respect and to generate orientation data indicative of said sensed movement and transmit it to the processing circuitry. Item (iv) that is performed by the processing circuitry further comprises controlling the movable platform to compensate said movement to allow said tracking based in response to the orientation data. Namely, controlling the movement of the movable platform and activating the desired antenna elements to continuously simultaneously track the primary and the secondary satellite performed by the processing circuitry is affected by the data received from the IMU. This allows the processing circuitry to control the movable platform and the activation/deactivation of the antenna to compensate changes in the orientation of the system with respect to the earth ground. This is specifically relevant when the system is placed on non-stable vessels, such as water vessels (boats, ships) or aircrafts.

In some embodiments of the system, the IMU comprises a set of orthogonal accelerometers and a set of orthogonal rate gyros.

In some embodiments of the system, a base of the movable platform is connected to an electrifying part via a rotary joint.

In some embodiments of the system, said first array consists of a single row of antenna elements. Due to the unique configuration of the system, it is allowed to use a single row of antenna elements that spreads over an arc conforming with the spherical shape of the lens.

In some embodiments of the system, the beams of two adjacent antenna elements are partially overlapping. This ensures a continuous field of view of the first array along an arc at a target distance from the system. The target distance is defined according to the type of satellites for communication with the system, e.g. Low Earth orbit satellites. The target distance typically defines the proximity between two adjacent antenna elements (the types of the antenna elements also affect the proximity requirement between two adjacent antenna elements).

In some embodiments of the system, item (ii) performed by the processing circuitry is performed to steer a tracking beam of the system, allowing the system to move only about two axes. Namely, the processing circuitry controllably activates and deactivates the antenna elements of the first array to electronically steer the tracking beam. In other words, the processing circuitry controllably activates and deactivates the antenna elements to yield an antenna beam steering effect, allowing it to operate with only two degrees of rotational movements.

In some embodiments of the system, said movable platform is capable of independent movement/rotation about three axes. Namely, the movable platform is configured to perform a roll, pitch and yaw resulting in a corresponding rotation of the lens.

In some embodiments of the system, the lens is a Luneburg lens.

In some embodiments, the system further comprises a second antenna array affixed to a second portion of the lens, conforming with a contour of said portion of the lens to allow transmission and/or detection of electromagnetic radiation through the lens. The processing circuitry is configured for controllably activating and deactivating at least one antenna element of said second array. The satellite data further comprises data indicative of the operative frequency band of the primary satellite and the secondary satellite, namely the transmission frequencies range of the satellites, e.g. Ku, Ka, X or other frequency bands. The first antenna array is configured for data communication in a first frequency band and the second antenna array is configured for data communication in a second frequency band. The processing circuitry is configured for controlling the movement of the movable platform and activating the desired antenna elements to simultaneously track the primary and the secondary satellite with a selected antenna array from the first antenna array and the second antenna array based on the satellite data. Namely, if the first antenna array is the relevant one for data communication with the current primary and secondary satellites then it is selected and used for the simultaneous tracking and if the second antenna array is the one that is suitable form the data communication with the satellites, then the second antenna array is selected and aligned with the satellites. By employing this configuration the system can be switched instantly from operation in a first frequency band to a second frequency band.

In some embodiments of the system, the first antenna array and the second antenna array intersect.

In some embodiments of the system, a first plane is defined by the projection of first antenna array that comprises the radius and a second plane is defined by the projection of second antenna array that comprises the radius; wherein the first plane and the second plane form an angle therebetween.

In some embodiments of the system, the angle is about 90°. The term “about” should be understood as +20°.

In some embodiments of the system, the first antenna array is disposed along a first arc path and the second antenna array is disposed along a second arc path different than the first path that does not overlap with the first arc path.

In some embodiments, the system further comprises at least one block up converter (BUC) and at least one low noise block converter (LNB) associated with each of the first antenna array and the second antenna array. This allows the system to support multi-frequency bands capability and multi-orbit capability, namely allowing the system to support LEO/MEO/GEO satellite constellations and multi frequency bands.

In some embodiments of the system, one or both of the first and second antenna array consist of a single row of antenna elements.

In some embodiments the of the system, the first antenna array may serve for tracking simultaneously and concurrently two non-geostationary (NGSO) satellites in the first frequency band and in another time, another array may serve for tracking simultaneously and concurrently two NGSO satellites in another frequency band.

In some embodiments of the system, the first array and the second antenna array may serve for tracking simultaneously and concurrently two NGSO satellites in two different frequency bands.

In some embodiments of the system, the second antenna array may be reduced to single or few radiating antenna elements and serve for tracking simultaneously and concurrently one NGSO satellite in one frequency band and one GEO satellite in another frequency band.

In some embodiments of the system, more than one another arrays may be present.

### Embodiments

The following are optional embodiments and combinations thereof in accordance with aspects of the present disclosure:
1. A system for continuous tracking and/or communicating with at least one satellite, comprising:
   a lens having a spherical or cylindrical symmetry mounted on a movable platform, said movable platform is capable of independent movement about at least two axes, resulting in a respective movement of said lens;
   a first array of antenna elements is affixed to a portion of the lens, conforming with a contour of said portion of the lens to allow transmission and/or detection of electromagnetic radiation through the lens;
   a processing circuitry configured for:
      (i) independently controlling the movement of the movable platform about each of the two or more axes;
      (ii) controllably activating and deactivating at least one antenna element of said first array;
      (iii) receiving satellite data indicative of the position of a primary satellite and a secondary satellite; and
      (iv) based on the satellite data, controlling the movement of the movable platform and activating the desired antenna elements to simultaneously track the primary and the secondary satellite.
2. The system of embodiment 1, wherein the movable platform comprises a seat portion on which the lens is mounted, said seat portion is coupled to a rotatable support frame that is rotatable about two non-parallel axes, first and second axes, by first and second drivers.
3. The system of embodiment 2, wherein the rotatable support frame encircles said lens.
4. The system of embodiment 2 or 3, wherein the movable platform comprises two arms coupling the rotatable segment to a rotatable base, being rotatable about a third axis normal to the first and second axes, by a third driver.
5. The system of embodiment 4, wherein a mid-point of said first array coincides with the third axis in a neutral state.
6. The system of embodiment 4 or 5, wherein one of the first and second drivers is formed on one of said two arms.
7. The system of any one of embodiments 2-6, wherein one of the first and second drivers is formed on said rotatable support frame.
8. The system of any one of embodiments 2-7, wherein said first array is coupled to said seat for said fixed attachment.
9. The system of any one of embodiments 1-8, wherein said first array extends along an arc that is less than half of the perimeter of the lens.
10. The system of any one of embodiments 1-9, wherein said first array is fixed to the external surface of said lens.
11. The system of any one of embodiments 1-9, wherein elements of said first array penetrate, at least partially, to an internal volume of said lens.
12. The system of any of embodiments 1-11, comprising a radar dome enclosing said lens and movable platform.
13. The system of any one of embodiments 1-12, comprising an inertial measurement unit (IMU) configured to sense the orientational state of the system with respect and generate orientation data indicative of said sensed movement and transmit it to the processing circuitry;
   wherein (iv) further comprises controlling the movable platform to compensate said movement to allow said tracking based in response to the orientation data.
14. The system of embodiment 13, wherein the IMU comprises a set of orthogonal accelerometers and a set of orthogonal rate gyros.
15. The system of any one of embodiments 1-14, wherein a base of the movable platform is connected to an electrifying part via a rotary joint.
16. The system of any one of embodiments 1-15, wherein said first array consists of a single row of antenna elements.
17. The system of any one of embodiments 1-16, wherein (ii) is performed to steer a tracking beam of the system.
18. The system of any one of embodiments 1-17, wherein said movable platform is capable of independent movement about three axes.
19. The system of any one of embodiments 1-18, wherein the lens is a Luneburg lens.
20. The system of any one of embodiments 1-19, comprising a second antenna array affixed to a second portion of the lens, conforming with a contour of said portion of the lens to allow transmission and/or detection of electromagnetic radiation through the lens;
   wherein the processing circuitry is configured for controllably activating and deactivating at least one antenna element of said second array;
   wherein the satellite data further comprises data indicative of the operative frequency band of the primary satellite and the secondary satellite;
   wherein the first antenna array is configured for data communication in a first frequency band and the second antenna array is configured for data communication in a second frequency band;
   wherein the processing circuitry is configured for controlling the movement of the movable platform and activating the desired antenna elements to simultaneously track the primary and the secondary satellite with a selected antenna array from the first antenna array and the second antenna array based on the satellite data.
21. The system of embodiment 20, wherein the first antenna array and the second antenna array intersect.
22. The system of embodiment 21, wherein a first plane is defined by the projection of first antenna array that comprises the radius and a second plane is defined by the projection of second antenna array that comprises the radius; wherein the first plane and the second plane form an angle therebetween.
23. The system of embodiment 22, wherein the angle is about 90°.
24. The system of embodiment 20, wherein the first antenna array is disposed along a first arc path and the second antenna array is disposed along a second arc path different than the first path that does not overlap with the first arc path.
25.The system of any one of embodiments 20-24, comprising at least one block up converter (BUC) and at least one low noise block converter (LNB) associated with each of the first antenna array and the second antenna array.
26. The system of any one of embodiments 20-25, wherein one or both of the first and second antenna array consist of a single row of antenna elements.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1C are schematic illustrations of different views of a non-limiting example of an embodiment of the satellite tracking system according to an aspect of the present disclosure. FIG. 1A is a side view, when the radar dome is transparent; FIG. 1B is a bottom perspective view without the radar dome; FIG. 1C is an additional side view without the radar dome.

FIG. 2 FIGS. 2A-2C are schematic illustrations of different examples of non-limiting embodiments of an implementation of an additional one or more antenna arrays to the system of FIGS. 1A-1C.

FIG. 3 is a schematic illustration of a non-limiting example exemplifying affixation of the antenna array to the lens such that at least part of the antenna elements penetrate the internal volume of the lens.

### DETAILED DESCRIPTION

The following figures are provided to exemplify embodiments and realization of the invention of the present disclosure.

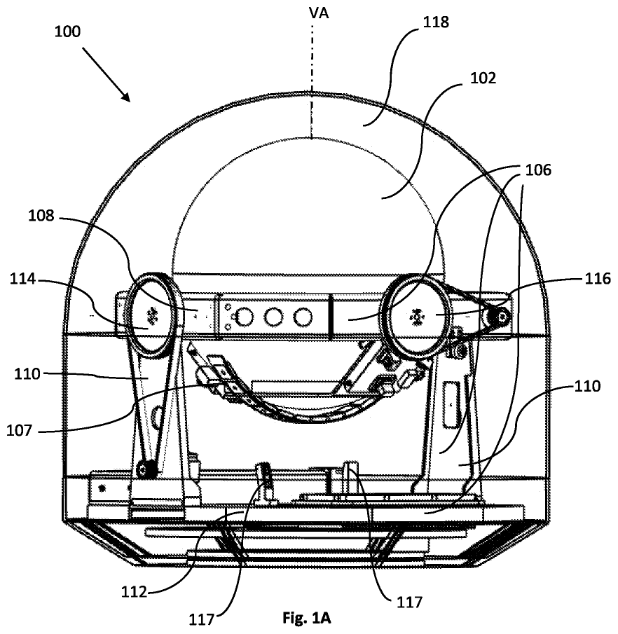

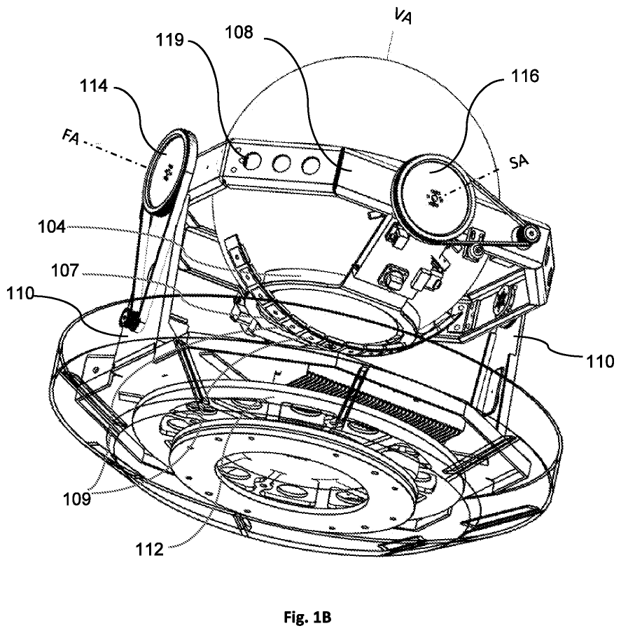

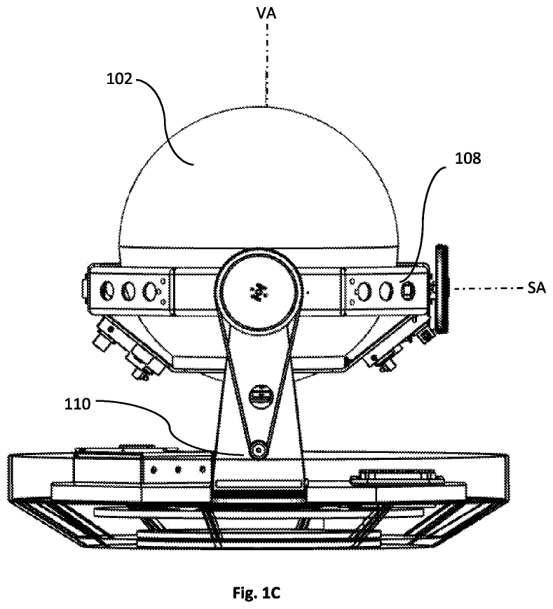

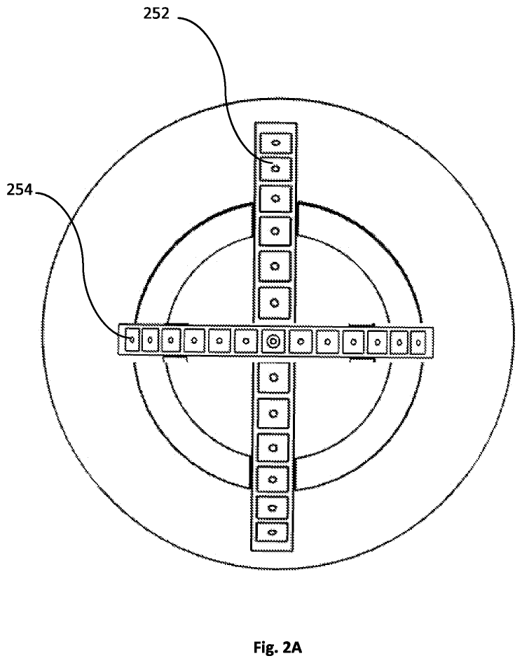

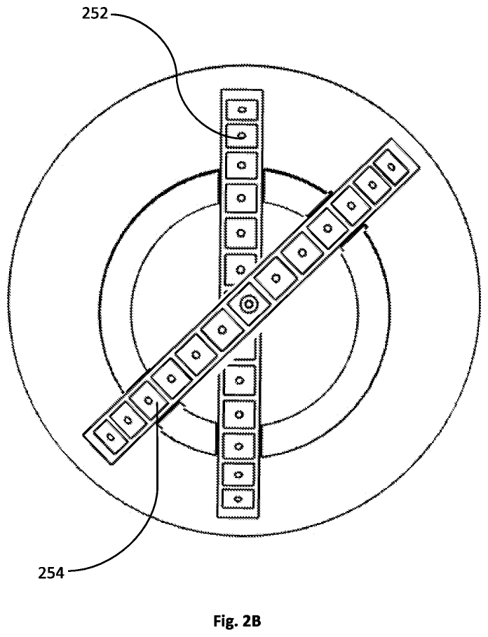

Reference is made to FIGS. 1A-1C, which show different views of a non-limiting example of an embodiment of the system according to an aspect of the present disclosure. The system 100 comprises a spherical lens 102, in this example a Luneburg lens, that is mounted on a lens seat portion 104 of a movable platform 106. An array of antenna elements 107 is disposed at an external portion of the lens 102, conforming with its external shape. Namely, the array 107 has the shape of an arch with a radius slightly larger than the radius of the lens 102. The array 107 is coupled to the lens seat 104 to be positioned in the desired position, though it is noted that the array can be directly coupled to the lens 102 and can even penetrate into the internal volume of the lens 102.

The lens seat 104 is coupled to a support structure 108 of the movable platform 106 that encircles the lens 102. The support structure 108 is mounted on first ends of two vertical arms 110, the second ends of the vertical arms 110 are coupled to a movable/rotatable base 112 that is rotatable about a vertical axis VA. A first driver 114 and a second driver 116 are associated with the support structure 108 and are configured to rotate the support structure 108 about two non-parallel axis, a first axis FA and a second axis SA, respectively. The first driver 114 is formed on one of the vertical arms 110 and the second driver 116 is formed on the support structure 108. In this specific example, the first axis FA and the second axis SA are orthogonal, though it is noted that the minimal requirement for these two axes is to be non-parallel. The first axis FA, the second axis SA, and the third, vertical axis VA are all non-parallel to one another, and in this specific example they are all orthogonal, allowing to obtain any desired rotational state of the lens 102 and the antenna array 107. This is enabled by the rotation of the two drivers 114 and 116 and the rotation of the movable base 112 that rotates the support structure 108, on which the lens 102 seats.

Rotational stoppers 117 are formed on the movable base 112 for limiting the rotational movement results from the driver 114 that sits om the vertical arm 110. This ensures that the rotation of the support structure, at least about the first axis, is limited to a certain rotational degree.

The support structure may include through-holed portions 119 that are intended to reduce its weight while not significantly reducing its structural strength.

Due to the unique design of the system, the antenna array 107 can be minimized, while simultaneously tracking of two satellites is still enabled. Therefore, in this example, the antenna array 107 consists of only one row of antenna elements 109. The movement capability of the movable platform 106 allows to align the antenna array with two satellites such that the beam of two antenna elements continuously tracks the satellites. The continuous tracking is allowed by continuous movement of the movable platform and continuous selection of relevant antenna elements in the array to be activated. A processing circuitry (not shown) is configured to receive satellite data that comprises information of the satellites to be tracked and their trajectory in the skyline. Based on the satellite data, the processing circuitry is further configured to (ii) control the movement of the movable platform, namely the movement of the movable base 112 and the actuation of the drivers 114 and 116 that affect the rotation about the first axis FA and the second axis SA; and (iii) control the activation/deactivation of the relevant antenna elements in order to align at least two antenna beams with two satellites simultaneously to allow continuous data communication with at least one satellite any time. Each time that one of the satellites is about to exit the line of sight of the system or upon receiving a command from the satellite network management to switch the tracking to a new satellite or new pair of satellites, the processing circuitry receives positional data of the next satellite in line to be tracked. At a certain time, the tracking and communication of the primary satellite that is about to exit the line of sight is terminated and the secondary satellite becomes the primary satellite to ensure continuous satellite communication. Upon such termination of tracking and communication with the primary satellite and tracking and communication with the secondary satellite, the movable platform is repositioned to position the beams of at least two antenna elements to be aligned with the new pair of satellites to be tracked, one antenna element aligned with the new primary satellite and the other with the new secondary satellite and so on. In other words, upon termination of tracking and communication with a primary satellite, the system enters a quick transition period, wherein in the end of this transition period the lens is set in a rotational position that is aligned with the new primary satellite and the new secondary satellite. The communication with the secondary satellite backing up the communication with the primary satellite and is ready to replace it upon termination of communication between the system and the primary satellite. It is to be noted that during the transition period, namely during the reposition of the system with the new alignment of the antenna elements with the new primary and secondary satellites, the tracking and the communication with the new primary satellites is continuous. Therefore, the processing circuitry is configured to plan the rotational movement of the lens and the activation of the antenna elements to ensure that continuous tracking and communication are maintained during the entire transitions period. It is to be noted that the beams of two adjacent antenna elements overlap is some degree to ensure that this continuous tracking and communication is allowed when a satellite is transitioning between a region of interest of one antenna element to an adjacent one.

The system further comprises an inertial measurement unit (IMU) for simultaneous dynamic stabilization of the two antenna beams. The combination of the lens with the array of electronically switchable antenna beams and the degree of freedom of three orthogonal axes (e.g., three orthogonal axes gimble) together with the IMU allows implementation of mathematical algorithm for dynamic stabilization of two antenna beam pointing continuously to two moving targets (satellites) while the whole system is mounted on moving (in Roll, Pitch and Yaw) platform, like a ship, an airborne or a ground vehicle. A unique combination of the electronically switchable antenna beams and gimble axes' positions corresponding to given IMU reading and given position of any two satellites, is found at each control cycle of the antenna system.

The system can include a radar dome 118 covering the lens and at least some parts of the movable platform, as can be seen in FIG. 1A.

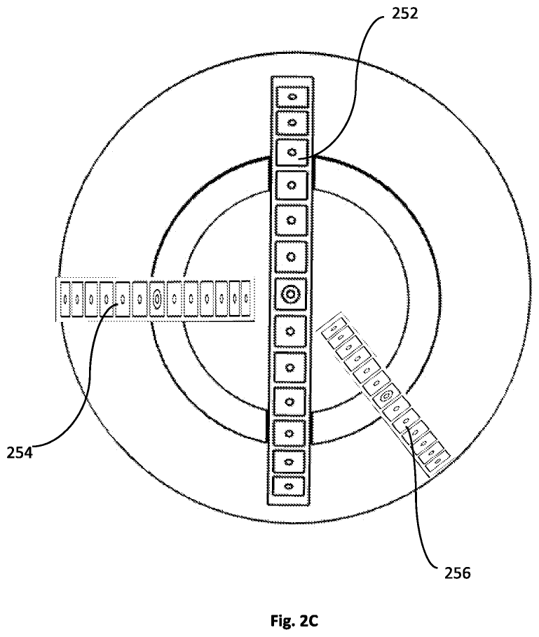

FIGS. 2A-2C are schematic illustrations of different examples of non-limiting embodiments of an implementation of an additional one or more antenna arrays to the system of FIGS. 1A-1C. The system can include a plurality of antenna arrays, each antenna arrays is configured to operate with satellites in a different frequency band, such as Ku, Ka, or X bands. Furthermore, each antenna array is supported by at least one block up converter (BUC) and at least one low noise block converter (LNB) for allowing communications with different satellite constellations, such as Low Earth Orbit (LEO), Medium Earth Orbit (MEO), or Geostationary orbit (GEO). The processing circuitry is configured for controllably activating and deactivating at least one antenna element of each of said additional antenna arrays and to control the movement of the movable platform and activating the desired antenna elements to simultaneously track the primary and the secondary satellite with a selected antenna array from the first antenna array and the second antenna array based on the satellite data, wherein the satellite data further comprises data indicative of the operative frequency band and/or the satellite constellation association of the primary satellite and the secondary satellite. Therefore, processing circuitry is configured to select the relevant antenna array and to align it with the satellites to simultaneously track the primary and the secondary satellites.

Therefore, the system is suitable for switching instantly between satellites from different constellations or with different frequency bands. FIGS. 2A-2B exemplify two antenna arrays, a first antenna array 252 and a second antenna array 254. In FIG. 2A the first antenna array 252 and the second antenna array 254 intersect and the planes that the projections of each arc path that are formed by the antenna arrays and include the radius are normal. FIG. 2C exemplifies that these planes are angled with respect to one another in an angle that is different than 90°.

FIG. 2C exemplifies three antenna arrays 252, 254, 256, each is disposed along a different arc path such that none of the arc paths intersect or overlap with another arc path of a different antenna array.

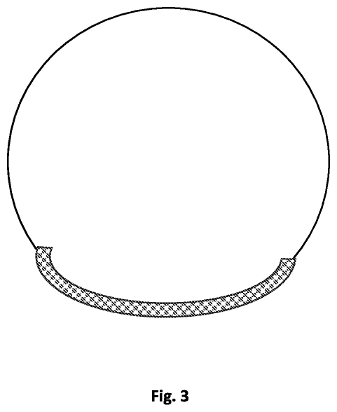

FIG. 3 is a schematic illustration of a non-limiting example exemplifying affixation of the antenna array 370 to the lens 372 such that at least part of the antenna elements 374 penetrate the internal volume 376 of the lens.

1. A system for continuous tracking and/or communicating with at least one satellite, comprising:
a lens having a spherical or cylindrical symmetry mounted on a movable platform, said movable platform is capable of independent movement about at least two axes, resulting in a respective movement of said lens;
a first array of antenna elements is affixed to a portion of the lens, conforming with a contour of said portion of the lens to allow transmission and/or detection of electromagnetic radiation through the lens;
a processing circuitry configured for:
(i) independently controlling the movement of the movable platform about each of the two or more axes;
(ii) controllably activating and deactivating at least one antenna element of said first array;
(iii) receiving satellite data indicative of the position of a primary satellite and a secondary satellite; and
(iv) based on the satellite data, controlling the movement of the movable platform and activating the desired antenna elements to simultaneously track the primary and the secondary satellite.

2. The system of claim 1, wherein the movable platform comprises a seat portion on which the lens is mounted, said seat portion is coupled to a rotatable support frame that is rotatable about two non-parallel axes, first and second axes, by first and second drivers.

3. The system of claim 2, wherein the rotatable support frame encircles said lens.

4. The system of claim 2, wherein the movable platform comprises two arms coupling the rotatable segment to a rotatable base, being rotatable about a third axis normal to the first and second axes, by a third driver.

5. The system of claim 4, wherein a mid-point of said first array coincides with the third axis in a neutral state.

6. The system of claim 4, wherein one of the first and second drivers is formed on one of said two arms.

7. The system of claim 2, wherein one of the first and second drivers is formed on said rotatable support frame.

8. The system of claim 2, wherein said first array is coupled to said seat for said fixed attachment.

9. The system of claim 1, wherein said first array extends along an arc that is less than half of the perimeter of the lens, and wherein said first array is fixed to the external surface of said lens.

10. (canceled)

11. The system of claim 1, wherein elements of said first array penetrate, at least partially, to an internal volume of said lens.

12. (canceled)

13. The system of claim 1, comprising an inertial measurement unit (IMU) configured to sense the orientational state of the system with respect and generate orientation data indicative of said sensed movement and transmit it to the processing circuitry;
wherein (iv) further comprises controlling the movable platform to compensate said movement to allow said tracking based in response to the orientation data.

14. (canceled)

15. The system of claim 1, wherein a base of the movable platform is connected to an electrifying part via a rotary joint.

16. The system of claim 1, wherein said first array consists of a single row of antenna elements.

17. The system of claim 1, wherein (ii) is performed to steer a tracking beam of the system.

18. The system of claim 1, wherein said movable platform is capable of independent movement about three axes.

19. The system of claim 1, wherein the lens is a Luneburg lens.

20. The system of claim 1, comprising a second antenna array affixed to a second portion of the lens, conforming with a contour of said portion of the lens to allow transmission and/or detection of electromagnetic radiation through the lens;
wherein the processing circuitry is configured for controllably activating and deactivating at least one antenna element of said second array;
wherein the satellite data further comprises data indicative of the operative frequency band of the primary satellite and the secondary satellite;
wherein the first antenna array is configured for data communication in a first frequency band and the second antenna array is configured for data communication in a second frequency band;
wherein the processing circuitry is configured for controlling the movement of the movable platform and activating the desired antenna elements to simultaneously track the primary and the secondary satellite with a selected antenna array from the first antenna array and the second antenna array based on the satellite data.

21. The system of claim 17, wherein the first antenna array and the second antenna array intersect, and wherein a first plane is defined by the projection of first antenna array that comprises the radius and a second plane is defined by the projection of second antenna array that comprises the radius; wherein the first plane and the second plane form an angle therebetween.

22. (canceled)

23. (canceled)

24. The system of claim 20, wherein the first antenna array is disposed along a first arc path and the second antenna array is disposed along a second arc path different than the first path that does not overlap with the first arc path.

25. (canceled)

26. The system of claim 20, wherein one or both of the first and second antenna array consist of a single row of antenna elements.
